(19) United States
(12) Patent Application Publication
(10) Pub. No.: US 2013/0222613 A1
(43) Pub. Date: Aug. 29, 2013

(54) WEBCAM MODULE HAVING A MILLIMETER-WAVE RECEIVER AND TRANSMITTER

(71) Applicant: WILOCITY, LTD., (US)

(72) Inventors: Alon Yehezkely, Haifa (IL); Dror Meiri, Zichron Yaakov (IL)

(73) Assignee: WILOCITY, LTD., Caesarea (IL)

(21) Appl. No.: 13/773,130

(22) Filed: Feb. 21, 2013

Related U.S. Application Data
(60) Provisional application No. 61/602,740, filed on Feb. 24, 2012.

(51) Int. Cl. G06F 3/00

(52) U.S. Cl. CPC G06F 3/005
USPC 348/207.1

(57) ABSTRACT

An apparatus built in a computing device and configured to allow the efficient radiation of millimeter-wave signals and capturing of at least video signals is provided. The apparatus comprises a body portion enclosed in a casing; a webcam module for capturing and receiving at least video and audio signals, wherein the webcam module includes at least a lens located in a first location of the body portion; an millimeter-wave array of active antennas configured to radiate the millimeter-wave signals, wherein the millimeter-wave array of active antennas is located in a second location of the body portion; and a radio frequency (RF) circuitry configured to control and activate the array of millimeter-wave active antennas, wherein an opening in the casing of the body portion is formed around the first location and the second location to expose the lens and the array of millimeter-wave active antennas.

### CROSS-REFERENCE TO RELATED APPLICATIONS

This application claims the benefit of U.S. Provisional Patent Application No. 61/602,740, filed on Feb. 24, 2012, the contents of which are herein incorporated by reference.

### TECHNICAL FIELD

The present invention relates generally to assembly of a circuit for transmitting and receiving millimeter wave signals in a computing device, and more particularly to an arrangement of millimeter wave antennas in a computing device.

### BACKGROUND

The 60 GHz band is an unlicensed band which features a large amount of bandwidth and a large worldwide overlap. The large bandwidth means that a very high volume of information can be transmitted wirelessly. As a result, multiple applications that require transmission of a large amount of data can be developed to allow wireless communication around the 60GHz band. Examples for such applications include, but are not limited to, wireless high definition TV (HDTV), a wireless docking station, wireless Gigabit Ethernet, and many others.

In order to facilitate such applications there is a need to develop integrated circuits (ICs), such as amplifiers, mixers, radio frequency (RF) analog circuits, and active antennas that operate in the 60 GHz frequency range. Such circuits should be fabricated as a chip that can be assembled on a printed circuit board (PCB). The size of the package may range from several to a few hundred square millimeters. In addition, there is a need to solve problems resulting from the current assembly of electronic devices, such as laptop computers, in order to enable efficient transmission and reception of millimeter wave signals.

A prime example for such a problem is illustrated in FIG. 1, which shows a typical assembly of a laptop computer 100 having radio transmission capabilities. A motherboard 110 of the computer 100 includes a RF module 120 that receives and transmits RF signals through a receive antenna 130 and a transmit antenna 140, which are located in the lid 150. Signals from the RF module 120 to the antennas 130 and 140 are transferred over wires 160. The motherboard 110 and the RF module 120 are installed in the base part of the computer 100.

The assembly illustrated in FIG. 1 cannot be adapted to enable the integration of 60 GHz communication applications in consumer electronics products, primarily because transferring high frequency signals over the wires 160 significantly attenuate the signals. Increasing the power of the signals at the RF module 120 would require designing complex and expensive RF circuits of the module 120. Thus, such assembly is not feasible for commercial uses in consumer electronics products of 60 GHz communication applications.

Recent solutions have been proposed to include the RF module operating the 60 GHz in the lid of the of the laptop computer, while the base-band module is integrated in the base of the computer. An illustration of such an assembly is shown in FIG. 2.

A laptop computer 200 includes an RF system 210 for transmission and reception of millimeter wave signals. The form factor of the RF system 210 is spread between the base plane 202 and the lid plane 205 of the laptop computer 200.

The RF system 210 includes two parts: a baseband module 220 and RF module 230 respectively connected to the base plane 202 and lid plane 205. The RF module 230 that includes active transmit (TX) and receive (RX) array of antennas. When transmitting signals, the baseband module 220 typically provides the RF module 230 with control, local oscillator (LO), intermediate frequency (IF), and power (DC) signals. The control signal is utilized for functions, such as gain control, RX/TX switching, power level control, sensors, and detectors readouts. Specifically, beam-forming based RF systems require high frequency beam steering operations which are performed under the control of the baseband module 220. The control signals are typically transferred from the baseband 220 of the system to the RF module 230.

The RF module 230 typically performs up-conversion, using a mixer (not shown) on the IF signal(s) to RF signals and then transmits the RF signals through the TX antenna according to the control of the control signals. The power signals are DC voltage signals that power the various components of the RF module 230.

In the receive direction, the RF module 230 receives RF signals at the frequency band of 60 GHz, through the active RX antenna and performs down-conversion, using a mixer, to IF signals using the LO signals, and sends the IF signals to baseband module 220. The operation of the RF module 230 is controlled by the control signal, but certain control information (e.g., feedback signal) is sent back to the baseband module 220.

However, other than the RF module 230 and an array of antennas, the assembly of the lid plane 205 typically also includes one or more cellular antennas (not shown) to communicate with a cellular network, an array of Wi-Fi antennas (not shown) to receive and transmit signals from an access point of a wireless local area network (WLAN), and one or two webcams (not shown). To avoid problems of signal interferences, the various antennas, i.e., the array of millimeter wave antennas (module 230), cellular antennas, and Wi-Fi antennas, should be positioned at a predefined distance from each other.

In addition, recently the cases of certain laptop computers (also known ultrabook computers) are being made of metal or carbon fiber materials, and the dimensions of the lid plane are small. To enable efficient energy radiation of signals in such computers, the various antennas are placed in areas that are not covered by the metal case. For example, the various antennas are located in the hinge between the lid and the base of the computer. This assembly also contributes to the problem with signal interferences and provides poor antenna radiation properties.

The above noted problems in laptop computers are also applicable to other handheld computing devices, such as smartphones, tablet computers, and the like. In such devices the area for placing additional components, and in particular, millimeter wave antennas, are even more limited. Thus, as can be readily understood, the available space for installing additional RF circuitry and active antennas for the 60 GHz band in order to allow efficient transmission or reception while avoiding signal interferences is very limited.

It would be therefore advantageous to provide a solution that overcomes these limitations.

### SUMMARY

Certain embodiments disclosed herein include an apparatus built in a computing device and configured to allow the efficient radiation of millimeter-wave signals and capturing of at least video signals. The apparatus comprises a body portion enclosed in a casing; a webcam module for capturing and receiving at least video and audio signals, wherein the webcam module includes at least a lens located in a first location of the body portion; an millimeter-wave array of active antennas configured to radiate the millimeter-wave signals, wherein the millimeter-wave array of active antennas is located in a second location of the body portion; and a radio frequency (RF) circuitry configured to control and activate the array of millimeter-wave active antennas, wherein an opening in the casing of the body portion is formed around the first location and the second location to expose the lens and the array of millimeter-wave active antennas.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a typical assembly of a laptop computer having radio transmission capabilities.

FIG. 2 a diagram illustrating the assembly of a laptop computer having millimeter wave radio transmission capabilities.

FIG. 3 is a schematic diagram of a laptop computer with a built-in combined webcam and RF module assembled in accordance with one embodiment.

FIGS. 4A and 4B show a front and back panel of a handled computing device with a built-in combined webcam and RF module assembled in accordance with one embodiment.

FIG. 5 is a block diagram of the combined webcam and RF module according to one embodiment.

FIG. 6 is a diagram of an assembly of the combined webcam and RF module in a lid plane of a laptop computer illustrating the exposure of the array of active antennas.

FIG. 7 shows an arrangement array of active antennas surrounding the perimeter of the lens according to another embodiment.

FIGS. 8 and 9 illustrate an implementation of the combined webcam and RF module constructed according to the disclosed embodiments.

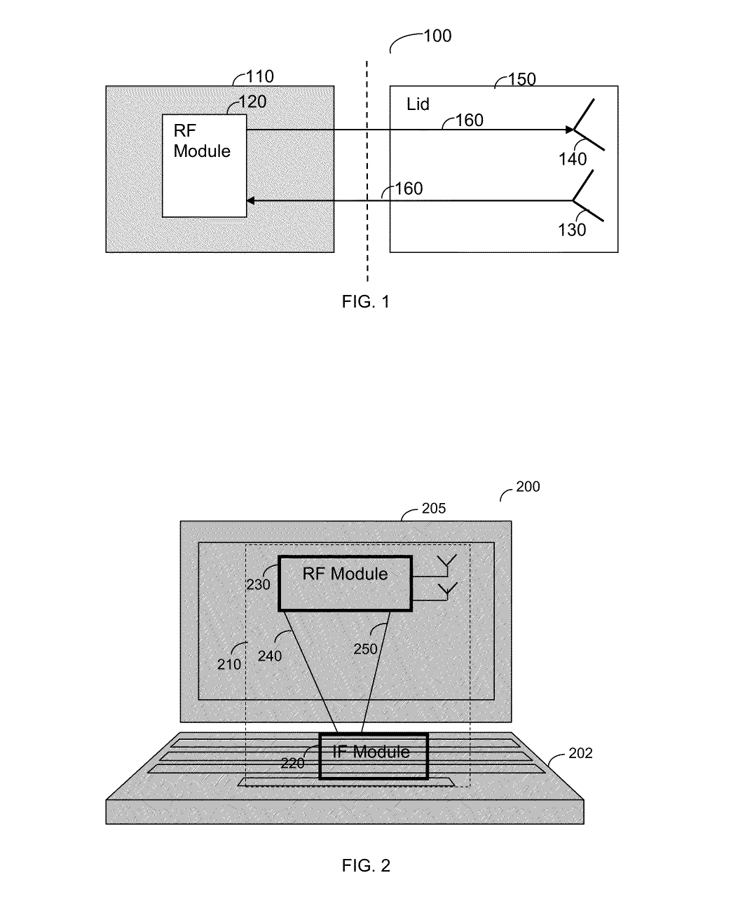

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

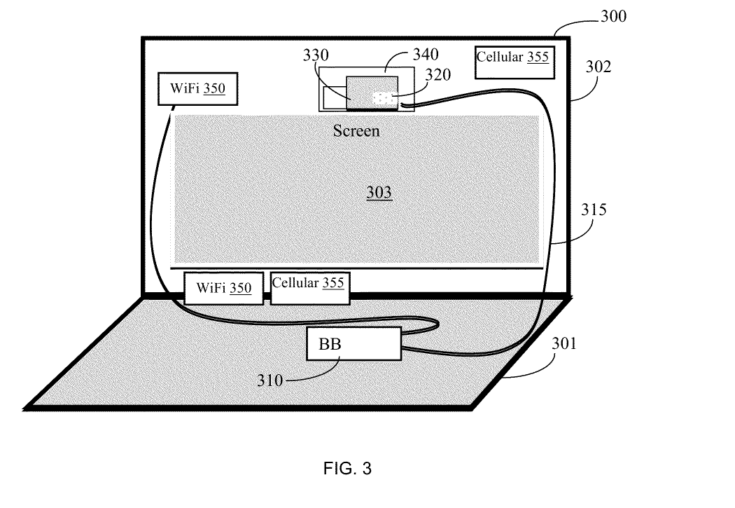

A schematic diagram of a laptop computer 300 assembled in accordance with one embodiment of the invention is shown in FIG. 3. The laptop computer 300 may be any handled computer, such as a netbook, a notebook, an ultrabook, and the like. The case of the laptop computer 300 may be made from metal, carbon fiber, or plastic materials. The teachings disclosed herein can also be applied to other handled computing devices, such as, but not limited to, smartphones, tablet computers, digital cameras, camcorders, and the like.

The form factor of a millimeter-wave RF system operable in the 60 GHz is speared between a base plane 301 and a lid plane 302 of the laptop computer 300. Specifically, the base plane 301 includes a baseband (BB) module 310 while the lid plane 302 includes the RF module 320 with an array of active antennas. The connection between the modules 310 and 320 is by means of one cable 315. The functionality of the baseband and RF modules 310 and 320 and the signals transferred between them have been described above.

Further assembled in the laptop computer 300 is an array of WiFi antennas 350 and/or cellular antennas 355. As schematically illustrated in FIG. 3, the antennas 350 and 355 can be placed in the lid 302, or in the hinge area between the base 301 and lid 302. It should be noted that more antennas, such as Bluetooth® and/or Global Positioning System (GPS) antennas can be integrated in the computer 300. This is also the case for smart phone and tablet computers.

According to certain embodiments disclosed herein, the RF module 320 and its array of active antennas are integrated in a webcam module 330, forming a combined webcam and RF module 340, which is assembled in the lid plane 302. The dimensions of the combined module 340 are the same as the webcam module 320. To assemble the webcam module 330 or the combined module 340 in the lid plane 302, an opening in the casing of the lid is formed. That is, the only portion in the lid plane 302 that is not covered by material used for encasing the lid is in the location of the combined module 340.

Thus, if the casing of the lid is made of metal, at the location of the webcam module 330 or the combined module 340, there is no metal casting. Therefore, it should be understood that locating the RF module 320 inside an opening created for the webcam module 330 or the combined module 340 would allow RF signals to efficiently radiate with low signal interferences. It should be further understood that in the alternative, where the array of active antennas are covered by metal casing, then a “caging” effect is created, and as such RF signals cannot be efficiently radiated outside of the casing of the lid. Therefore, RF signals cannot be efficiently received and transmitted by the RF module 320. Whereas in the proposed assembly, the RF signals can freely radiate through an opening (or a hole) that exposes the lens of the webcam module 330. In one embodiment, the combined webcam and RF module 340 is disposed in a lid 302 above a screen 303 of laptop computer 300.

A webcam module typically includes a body portion enclosed within its casing. The body portion has an accommodated space inside for accommodating an electronic circuits and lens. The electronic circuits may include an image processor, an image sensor, a peripheral circuitry, and a connector (e.g., a USB connector). According to certain embodiments, the RF module 320 and its array of active antennas are placed in the accommodated space within a webcam module, to contain the combined webcam and RF module 340.

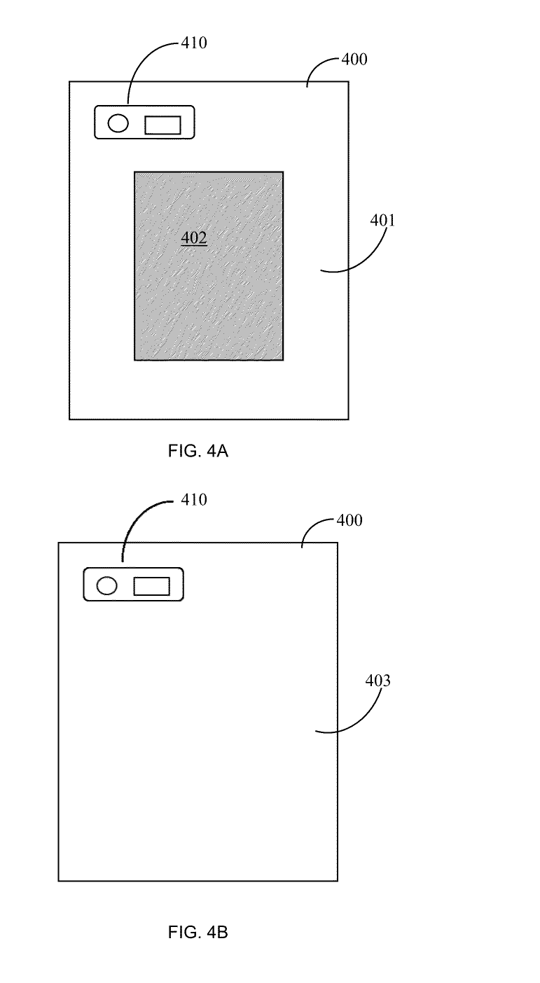

In another embodiment, as illustrated in FIG. 4A, the combined webcam and RF module 410 is disposed in the front panel 401 at the side of the device's screen 402. Alternatively or collectively, as illustrated in FIG. 4B, the combined webcam and RF module 410 is disposed in a back panel 403 of a computing device 400. The arrangements illustrated in FIGS. 4A and 4B are suitable for handheld computing devices, such as smartphones, and tablet computers. It should be noted that in all of the embodiments depicted in FIGS. 3, 4A and 4B, the webcam and RF module 410 is a built-in module of the computing device.

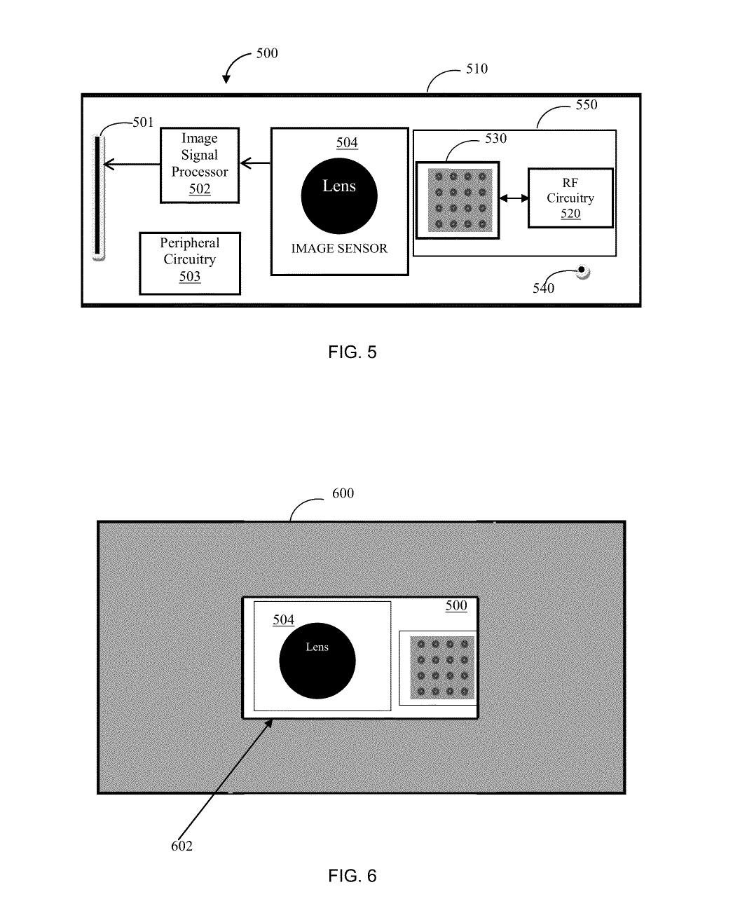

FIG. 5 shows an exemplary and non-limiting block diagram illustrating a combined webcam and RF module 500 constructed according to one embodiment. The module 500 allows capturing images as well as receiving and transmitting millimeter wave signals. In a particular embodiment, the RF millimeter wave signals are in the 60 GHz.

In a body portion 510 of the combined webcam and RF module 500 there are installed on a printed circuit board (PCB) a connector 501, an image processor 502, a peripheral circuit 503, and lens 504 integrated in an image sensor chip (or IC). The PCB is not illustrated in FIG. 5. The body portion 510 is enclosed within its casing. The components 501, 502 and 504 are elements of a standard webcam module. The connector 501 may be a USB micro connector, such as USB 2.0 or USB 3.0, or any other type of high-speed serial bus. In certain implementation, the PCB can be replaced with any other substrate material used to for electronic modules.

In accordance with an embodiment disclosed herein, a RF circuitry 520 and an array of millimeter wave active antennas 530 are also included in the body portion 510. The RF circuitry 520 and the array of active antennas 530 comprise the RF module 550.

In an embodiment, the active antennas in the array of active antennas 530 can be controlled to receive/transmit radio signals in a certain direction, to perform beam forming, and for switching from receive to transmit modes. In one embodiment, an active antenna in the array 530 may be a phased array antenna in which each radiating element can be controlled individually to enable the usage of beam-forming techniques and to allow antenna diversity, for example, spatial diversity and/or polarization diversity. The array of active antennas 530 include a plurality of radiating elements designed to support efficient reception and transmission of millimeter wave signals in at least the 60 GHz frequency band. According to one embodiment, the radiating elements of the active antennas 530 are implemented using metal patterns in a multilayer substrate of the PCB.

The location of the array of active antennas 530 inside the body portion 510 of the combined webcam RF module 500 is selected so that the antennas 530 are not covered by the casing of the body portion 510 and the casing of the computing device (e.g., the casing of a lid or panel).

As illustrated in FIG. 6, the combined webcam and RF module 500 is assembled in a lid plane 600 of the laptop computer. As can be shown the casing (labeled as 601) of the lid covers only a portion the module 500. Specifically, the lens 504 and array of active antennas 530 are exposed through an opening 602 allowing visibility to objects. The opening 602 is typically covered by a clear plastic material. Thus, RF signals can also be radiated through the opening 602 without signal interferences or signal losses. In another embodiment, the active antennas can be placed behind the lens 504, preferably facing an opposite direction than the image sensor.

Referring back to FIG. 5, the RF circuitry 520 typically performs up-conversion, using a mixer (not shown) on the IF signals received from the baseband module to the RF signals, and then transmits the RF signals through the TX antenna according to control signals also received from the baseband module. In the receive direction, the RF circuitry 520 receives RF signals at the frequency band of 60 GHz, through the active RX antenna and performs down-conversion, using a mixer, to IF signals using the LO signals, and sends the IF signals to the baseband module. According to one embodiment, the IF, LO, and control signals are received from a baseband module over a cable connected to a connector 540. The connector 540 may be a mini micro coaxial connector (UFL) connector or other suitable attachment structure. In one embodiment, the RF module 550 including the RF circuitry 520 and active antennas 530 may be fabricated in a single integrated circuit (IC).

According to another embodiment, the array of active antennas 530 is a triple-band antenna designed to receive and transmit millimeter wave signals in the WiFi bands of 2.4 GHz and 5 GHz as well as the WiGig band of 60 GHz. Such a triple-band antenna includes a printed antenna having two wings for transmitting and receiving low-frequency signals in any one of the 2.4 GHz and 5 GHz frequencies, and an antenna array including a plurality of radiating elements being printed on one of the wings of the printed antenna; the antenna array transmits and receives the 60 GHz band signals. An example of a triple-band antenna can be also found in a co-pending application Ser. No. 13/052,736, to Myszne, et al., assigned to the common assignee of the present application.

The power signals that power the various components of the RF circuitry 520 are supplied by the baseband module over the cable connected to the connector 540. In another configuration, such power signals are supplied through the connector 501 (e.g., a USB connector) or a power supply that powers the webcam's electric components.

The peripheral circuitry 503 is also installed on the PCB in the body portion 510 of the combined webcam and RF module 500. The peripheral circuitry 503 includes electronic components, such as capacitors, resistors, and inductors, power management circuitry (e.g. voltage regulators), a time reference (e.g. crystal) that can be shared with the image sensor and image signal processor 502, and the RF circuitry 520.

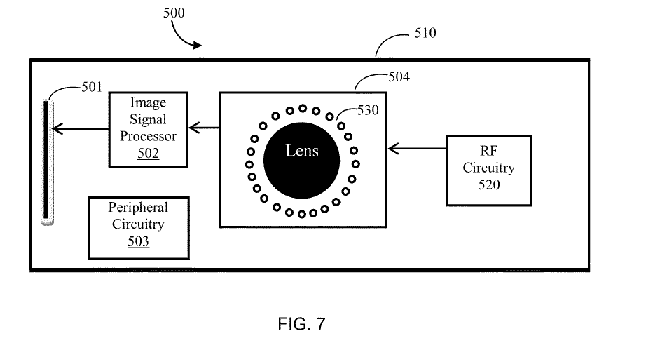

FIG. 7 shows another arrangement of the array of active antennas 530 of the combined RF and webcam module according to one embodiment. The active antennas 530 are designed to surround the perimeter of the lens 504. In one embodiment, the distance between radiating elements in the array of active antennas 530 is typically between a half wavelength and a full wavelength. The connections between the radiating elements and the RF circuitry 520 are by means of traces (not shown) being routed through metal vias in the substrate. It should be noted that the radiating elements of the array of active antennas 530 are designed to support efficient reception and transmission of millimeter wave signals, particularly in the frequency band of 60 GHz. The arrangement of the array of active antennas 530 as shown in FIG. 7 may be utilized in a device when the opening in the casing of the device is limited.

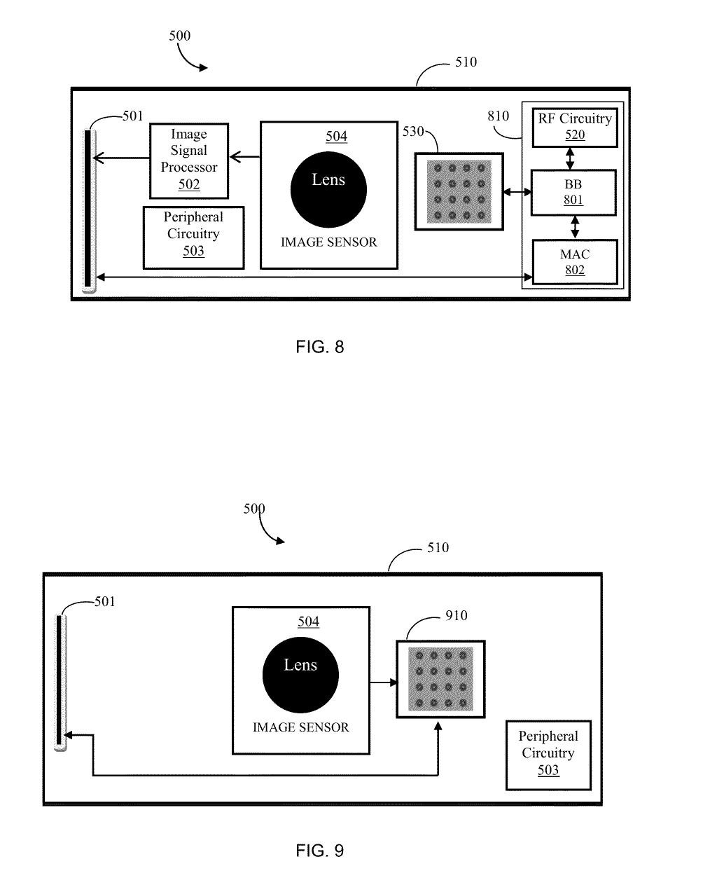

In another arrangement of the combined webcam and RF module 500 depicted in FIG. 8, the body portion 510 of the module 500 includes a baseband (BB) module 801, a medium access control (MAC) layer circuit 801, and the RF circuitry in addition to the connector 501, the signal processor 502, and the image sensor and lens 504 discussed above. In one embodiment, an IC 810 integrates the baseband module 801, a medium access control (MAC) layer circuit 802, and the RF circuitry 520. The baseband module 801 has the functionality described above, for example, with respect to FIG. 2.

Thus, in this embodiment shown in FIG. 8, there is no connector 540, and the IF, control, and LO signals are provided by the baseband module 801. The MAC layer circuit 802 in the IC 810 provides the MAC functionality according, for example, to IEEE 802.11ad communication protocol. The RF circuitry 520 controls and activates the array of millimeter wave active antennas 530 discussed above. The connector 501 is a high-speed serial connector being connected to a high-speed serial cable (e.g., USB3, PCIe, and the like). Over the high-speed serial cable video signals captured and processed by the webcam module as well as data signals output by or to be processed by the MAC layer circuit 802 are also transported. The data signals processed by the MAC layer circuit 802 are compliant with the IEEE 802.11ad communication protocol.

In yet another arrangement depicted in FIG. 9, the body portion 510 of the combined webcam and RF module 500 includes only the connector 501, the peripheral circuitry 503, the lens 504 connected to the image sensor, and an IC 910. The IC 910 integrates the webcam's image processor (e.g., processor 502), a baseband module, a MAC layer circuit, a RF circuitry (520), and the array of millimeter wave active antennas. The functions of these components are discussed in detail above.

According to this embodiment, the array of active antennas is implemented on the substrate upon which the IC 910 is mounted. The IC 910 is fabricated on a multi-layer substrate and metal vias that connect between the various layers. The multi-layer substrate may be a combination of metal and dielectric layers and can be made of materials, such as a laminate (e.g., FR4 glass epoxy, Bismaleimide-Triazine), ceramic (e.g., low temperature co-fired ceramic LTCC), polymer (e.g., polyimide), PTFE (Polytetrafluoroethylene) based compositions (e.g., PTFE/Cermaic, PTFE/Woven glass fiber), and Woven glass reinforced materials (e.g., woven glass reinforced resin), wafer level packaging, and other packaging, technologies and materials.

It should be noted that in other embodiments, the combined webcam and RF module 500 can also include circuitry to support WiFi connectivity integrated, for example, in the IC 910. In this configuration, the active antennas are constructed as a triple-band antenna described above.

It is important to note that these embodiments are only examples of the many advantageous uses of the innovative teachings herein. Specifically, the innovative teachings disclosed herein can be adapted in any type of consumer electronic devices where reception and transmission of millimeter wave signals is needed. Moreover, some statements may apply to some inventive features but not to others. In general, unless otherwise indicated, it is to be understood that singular elements may be in plural and vice versa with no loss of generality.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An apparatus built in a computing device and configured to allow the efficient radiation of millimeter-wave signals and capturing of at least video signals, comprising:
a body portion enclosed in a casing;
a webcam module for capturing and receiving at least video and audio signals, wherein the webcam module includes at least a lens located in a first location of the body portion;
a millimeter-wave array of active antennas configured to radiate the millimeter-wave signals, wherein the millimeter-wave array of active antennas is located in a second location of the body portion; and
a radio frequency (RF) circuitry configured to control and activate the array of millimeter-wave active antennas, wherein an opening in the casing of the body portion is formed around the first location and the second location to expose the lens and the array of millimeter-wave active antennas.

2. The apparatus of claim 1, wherein the webcam module, the RF circuitry, and the millimeter-wave array of active antennas are mounted on a printed circuit board (PCB), wherein the PCB is located inside of the body portion enclosed in the casing.

3. The apparatus of claim 1, wherein the webcam module further comprises:
an image sensor;
an image signal processor;
a serial bus connector, wherein through the serial bus connector at least a power signal is supplied to the image sensor, the image signal processor, and the RF circuitry.

4. The apparatus of claim 2, wherein the apparatus further comprises:
a peripheral circuitry being installed on the PCB, the peripheral circuitry includes discrete electronic components shared with the image signal processor and the RF circuitry.

5. The apparatus of claim 1, wherein the second location is alongside the first location.

6. The apparatus of claim 1, wherein the second location is the inside perimeter of the first location.

7. The apparatus of claim 2, wherein the array of active antennas includes a plurality of radiating elements, wherein the distance between radiating elements is between a half wavelength and a full wavelength of a millimeter-wave signal.

8. The apparatus of claim 7, wherein the radiating elements of the array of active antennas are printed on a substrate of the combined webcam and RF module.

9. The apparatus of claim 1, wherein the array of active antennas is an array of phased-array antennas.

10. The apparatus of claim 9, wherein the RF circuitry is further configured to control the phase per antenna in order to establish a beam-forming operation for the phased-array antenna.

11. The apparatus of claim 1, wherein the array of active antennas is a triple-band antenna.

12. The apparatus of claim 3, further comprises:
a connector connected to a cable for receiving at least one of a local oscillator (LO) signal, a control signal, and a baseband signal.

13. The apparatus of claim 3, wherein the webcam module and the RF circuitry are integrated in a single integrated circuit (IC).

14. The apparatus of claim 3, wherein further comprises:
a baseband module for performing at least up conversion and down conversion of the millimeter wave signals;
a medium access control (MAC) layer circuit for processing data signals, wherein the data signals are processed according to the IEEE 802.11ad communication protocol.

15. The apparatus of claim 14, wherein a high-speed serial cable is connected to the high-speed serial connector, wherein the at least video signals captured by the webcam module, and the data signals compliant with the IEEE 802.11ad communication protocol are transported over the high-speed serial cable.

16. The apparatus of claim 14, wherein the webcam module, the RF circuitry, the baseband module, and the MAC layer circuit are integrated in a single integrated circuit (IC).

17. The apparatus of claim 1, wherein the apparatus is disposed in an upper portion of a lid of the computing device.

18. The apparatus of claim 1, wherein the apparatus is disposed in at least one of: a front panel and a back panel of the computing device.
